(19) United States
(12) Patent Application Publication
(10) Pub. No.: US 2019/0343272 A1
(43) Pub. Date: Nov. 14, 2019

(54) HEIGHT-ADJUSTABLE WORKSTATION AND OUTPUT-ADJUSTING TASK LIGHT

(71) Applicant: Teknion Limited, Toronto (CA)

(72) Inventors: Dannion Riggs Smith, Cambridge (CA); Hamid Zebarjad, Richmond Hill (CA); Adam Douglas Haworth Sinclair, Mount Albert (CA); Ryan Christopher Michaelis, North York (CA); Hanna Shaheen, Toronto (CA); Azam Nakuhda, Pickering (CA); Jun Zhang, Stouffville (CA)

(21) Appl. No.: 16/400,394

(22) Filed: May 1, 2019

Related U.S. Application Data
(60) Provisional application No. 62/671,231, filed on May 14, 2018.

(51) Int. Cl. A47B 9/20; F16M 11/24; F16M 11/12

(52) U.S. Cl. CPC A47B 9/20; F16M 11/12; F16M 11/24

(57) ABSTRACT

A height-adjustable workstation includes a worksurface and a worksurface actuator for supporting the worksurface above a floor surface. The worksurface actuator is operable to raise and lower the worksurface relative to the floor surface. A display support apparatus secured to the worksurface includes a display support actuator and a display mount. The display support actuator is operable to move the display mount relative to the worksurface between a neutral position and an offset position. The display support actuator is configured to move the display support to the offset position in response to the worksurface being raised above a pre-determined height relative to the floor surface, and to move the display support to the neutral position in response to the worksurface being lowered below the pre-determined height. The height-adjustable workstation may optionally include an output-adjusting task light.

### CROSS-REFERENCE TO RELATED APPLICATIONS

This application claims the benefit of U.S. Provisional Application No. 62/671,231 filed on May 14, 2018, which is incorporated by reference herein in its entirety.

### FILED

This disclosure relates generally to a height-adjustable workstation, and more specifically to a workstation with a height-adjustable worksurface and a display support apparatus that can automatically move a display mount relative to the worksurface when the height of the worksurface is adjusted. This disclosure also relates to an output-adjusting task light.

### INTRODUCTION

Height-adjustable workstations are well known. Typically, height-adjustable workstations include a worksurface that can be adjusted between various heights above a floor surface, including e.g. a lowered position (to accommodate a seated user) and a raised position (to accommodate a standing user).

Display or monitor supports are also well known. Such supports are commonly used, for example, to support a display of a computing device above a furniture piece, such as a desk or other worksurface.

Task lights are also well known. Such lights are commonly placed on a desk or other worksurface to provide illumination to the worksurface.

### SUMMARY

The following summary is provided to introduce the reader to the more detailed discussion to follow. The summary is not intended to limit or define any claimed or as yet unclaimed invention. One or more inventions may reside in any combination or sub-combination of the elements or process steps disclosed in any part of this document including its claims and figures.

In accordance with a broad aspect, there is provided a height-adjustable workstation comprising: a worksurface; at least one worksurface actuator secured to the worksurface for supporting the worksurface above a floor surface; the at least one worksurface actuator being operable to raise and lower the worksurface relative to the floor surface between a lowered position and a raised position; and a display support apparatus secured to the worksurface, the display support apparatus comprising a display support actuator and a display mount; the display support actuator being operable to move the display mount relative to the worksurface between a neutral position and an offset position in which the display mount is further from the worksurface than when the display mount is in the neutral position; wherein the display support actuator is configured to move the display support to the offset position in response to the worksurface being raised above a pre-determined height relative to the floor surface, and wherein the display support actuator is configured to move the display support to the neutral position in response to the worksurface being lowered below the pre-determined height.

In some embodiments, the height-adjustable workstation further comprises at least one height-adjustable leg secured to the worksurface for supporting the worksurface on the floor surface, the at least one height-adjustable leg comprising the at least one worksurface actuator.

In some embodiments, the display support actuator comprises a ball screw.

In some embodiments, the height-adjustable workstation further comprises a control panel operably coupled to the at least one worksurface actuator, the control panel comprising an interface for receiving at least: a first input directing that the worksurface be raised, and a second input directing that the worksurface be lowered.

In some embodiments, the control panel further comprises a digital display.

In some embodiments, the control panel is operable to receive an offset input for selecting a difference between the offset position and the neutral position.

In some embodiments, the offset input comprises selecting the difference between the offset position and the neutral position in one inch increments.

In some embodiments, the pre-determined height is between 30 and 42 inches above the floor surface.

In some embodiments, the pre-determined height is about 32 inches above the floor surface.

In some embodiments, in the offset position, the display mount is between one and six inches further from the worksurface than when the display mount is in the neutral position.

In accordance with another broad aspect, there is provided an output-adjusting task light for placement on a worksurface located in an environment, the environment having an environment illuminance level, the output-adjusting task light comprising: a base configured for placement on the worksurface; a frame operatively connected to the base, the frame supporting a light emitting element above the worksurface, the light emitting element being operable to project light downwardly towards the worksurface; a sensor positioned above the light emitting element, the sensor being operable to monitor the environment illuminance level; and a controller operatively coupled to the light emitting element and the sensor, wherein the controller is configured to adjust an output level of the light emitting element based on the environment illuminance level and a target worksurface illuminance level.

In some embodiments, the controller is configured to automatically adjust the output level of the light emitting element in response to a change in the environment illuminance level.

In some embodiments, the controller is configured to determine the output level of the light emitting element based on a difference between the target worksurface illuminance level and the environment illuminance level.

In some embodiments, the output-adjusting task light further comprises an interface for at least one of receiving the target worksurface illuminance level and adjusting the target worksurface illuminance level.

In some embodiments, the sensor is positioned on an upper surface of the frame.

In some embodiments, the output level of the light emitting element is adjustable between 0 and 100 lux.

In accordance with another broad aspect, there is provided a height-adjustable workstation in combination with an output-adjusting task light.

It will be appreciated by a person skilled in the art that a method or apparatus disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a perspective view of a height-adjustable workstation according to one embodiment, with a worksurface in a raised position;

FIG. 2 is a side elevation view of the workstation of FIG. 1, with the worksurface in a lowered position, and with a display mount in a neutral position;

FIG. 3 is a side elevation view of the workstation of FIG. 1, with the worksurface in a raised position, and with the display mount in an offset position;

FIG. 4 is a perspective view of an output-adjusting task light according to one embodiment;

FIG. 5 is a perspective view of the height-adjustable workstation of FIG. 1 with the output-adjusting task light of FIG. 4 positioned on the worksurface, with the worksurface in a lowered position; and

FIG. 6 is a perspective view of the height-adjustable workstation and output-adjusting task light of FIG. 5, with the worksurface in a raised position.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Height-adjustable workstations allow a user to adjust the height of a worksurface relative to a floor surface. For example, a user may selectively adjust the height of the worksurface based on e.g. ergonomic preferences based on their specific body dimensions, posture preferences, and/or requirements for a particular task. For example, a user may wish to work in a standing position at certain times and/or when performing certain tasks, and may wish to work in a seated position at certain other times and/or when performing certain other tasks. Height-adjustable workstations (e.g. height-adjustable tables) may allow a user to easily alternate between seated and standing positions. Examples of height-adjustable tables include hiSpace height-adjustable tables available from Teknion Limited of Canada.

While the apparatus and methods disclosed herein are described specifically in relation to a worksurface having a rectangular shape, it will be appreciated that the apparatus and methods may alternatively be used with worksurfaces having any other shape.

Often, the worksurface of a height-adjustable workstation is used to support a display of a computing device, e.g. a flat-panel computer monitor. For example, a display may be simply placed on the worksurface. Alternatively, a display or monitor support, e.g. a counterbalancing support arm, may be provided to support a display above worksurface.

Typically, the position of the display relative to the worksurface is static. Accordingly, when the height of the worksurface is adjusted relative to the floor surface, the height of the display relative to the floor surface is varied, but the vertical position of the display relative to the worksurface remains fixed. For example, raising the worksurface by 12 inches relative to the floor also raises the display by 12 inches relative to the floor, although the height of the display relative to the worksurface is unchanged.

However, for many users, when the user is in a seated work position a preferred (e.g. ergonomically preferred) height of the display relative to the worksurface is different than when the user is in a standing work position. In most cases, when in a standing work position the display is preferably higher relative to the worksurface than when in a seated work position. This increase in the preferred height of the display relative to the worksurface when a user is in a standing position (i.e. when the worksurface is in a raised position) may be characterized as an offset or “delta” relative to the preferred height of the display relative to the worksurface when the user is in a seated position (i.e. when the worksurface is in a lowered position).

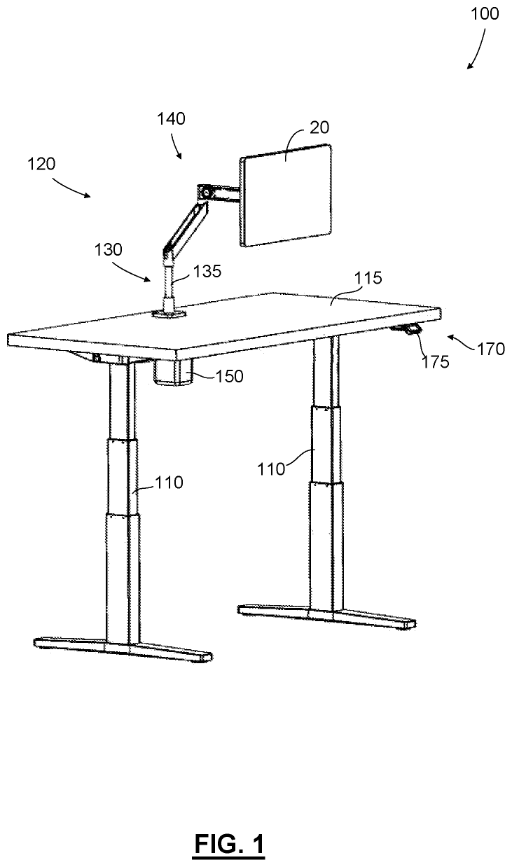

FIGS. 1 to 3 illustrate an example of a height-adjustable workstation (which may also be referred to as a height-adjustable table), referred to generally as 100. Height-adjustable workstation 100 may be used within an individual's office, in a shared workspace, or in a common area (e.g. a lobby, a retail environment).

In the illustrated example, height-adjustable workstation 100 includes a worksurface 115 and a pair of height-adjustable legs 110. The height-adjustable legs 110 are secured to the underside of the worksurface 110, and support the workstation above a floor surface 10. Each height-adjustable leg 110 may include an actuator for selectively extending and retracting the leg 110 in the vertical direction. In the illustrated example, each leg 110 is a telescopic leg with an actuator positioned interior of the leg, and the leg actuator is therefore not shown in the Figures. The leg actuators may be characterized as worksurface actuators, as extending the legs raises the worksurface and retracting the legs lowers the worksurface. It will be appreciated that alternative embodiments may include only a single leg and/or actuator, and/or the worksurface may be otherwise supported above a floor surface (e.g. cantilevered from a wall, with one or more actuators configured to raise and lower the worksurface).

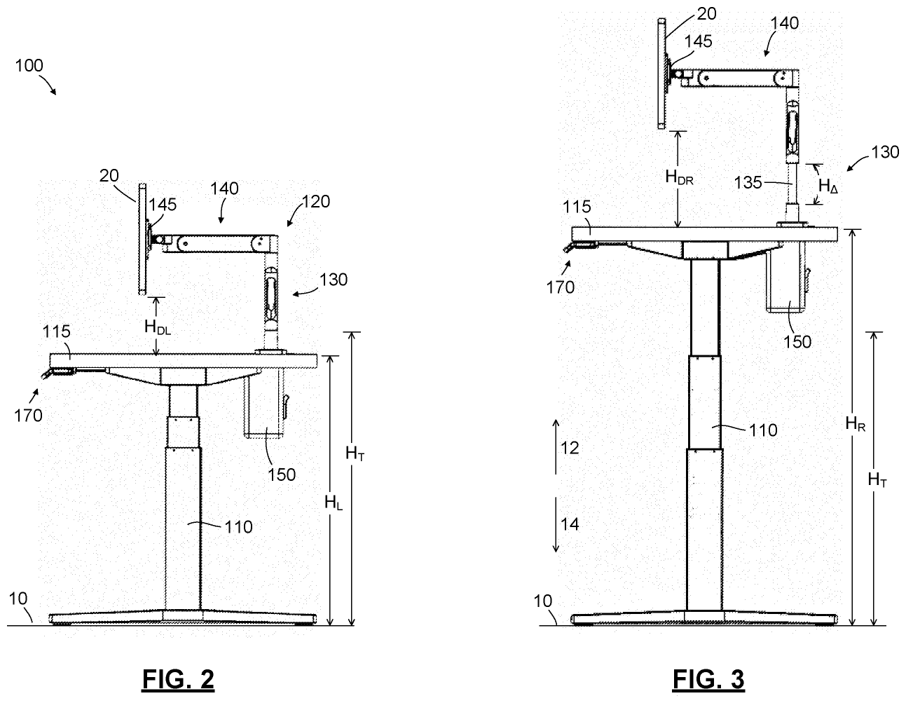

In FIG. 2, the worksurface 115 is illustrated in a lowered position. In FIGS. 1 and 3, the worksurface 115 is illustrated in a raised position in which the worksurface 115 is positioned higher relative to the floor surface 10 than when in the lowered position. When the worksurface 115 is in a lowered position (i.e. proximate the floor surface 10), the height-adjustable workstation 100 may be conducive for seated work. When the worksurface 115 is in a raised position (i.e. distal from the floor surface 10), the height-adjustable workstation 100 may be conducive for standing work.

Height-adjustable workstation 100 also includes a display support apparatus, referred to generally as 120, for supporting a display 20 above the worksurface 115. In the illustrated example, display support apparatus 120 includes a display mount 145 for securing a display 20 to the display support apparatus. For example, display mount 145 may be adapted to be secured to a rear panel of display 20 in accordance with one or more display mounting standards, such as a VESA standard.

Display support apparatus 120 also includes a display height-adjustment member 130 and an optional counterbalancing display support arm assembly 140 positioned between the display height-adjustment member 130 and the display mount 145. Counterbalancing support arm assembly 140 may facilitate adjustment (e.g. manual adjustment) of the position of the display 20 relative to the worksurface. It will be appreciated that a non-counterbalancing display support arm may be provided in alternative embodiments. Alternatively, display mount 145 may be secured directly to the display height-adjustment member 130.

Display height-adjustment member 130 can be extended and retracted to adjust the height of the display 20 relative to the worksurface 115. In the illustrated example, display height-adjustment member 130 includes a telescopic drive rod 135. One end of the drive rod 135 is coupled to an end of the counterbalancing display support arm assembly 140. The other end of drive rod 135 is coupled to a display support actuator 150. Display support actuator 150 is operable to selectively adjust the height-adjustment member 130 between a neutral position and an extended or offset position, thereby adjusting the relative height of the display 20 relative to the worksurface 115.

Preferably, display support actuator 150 comprises a ballscrew or other linear actuator to extend and retract display height-adjustment member 130, although other configurations or actuators may be used in alternative embodiments.

In the illustrated example, the display support actuator 150 is positioned below the work surface 115, and the drive rod 135 extends through an aperture in the worksurface 115. Positioning the actuator 150 below the worksurface 115 may provide a desired aesthetic appearance (e.g. by ‘hiding’ or otherwise de-emphasizing the visibility of the actuator 150), although it will be appreciated that other actuator configurations may alternatively be used.

As discussed above, when the worksurface is in a raised position, the preferred height of the display 20 relative to the worksurface 115 may be higher than when the worksurface is in a lowered position. Accordingly, when the worksurface is raised from a lowered position to a raised position, the display support actuator 150 may be used to automatically adjust the height of the display 20 relative to the worksurface 115 (which may be characterized as the ‘display height’) by a distance equal to the offset or “delta” between a ‘seated’ preferred display height and a ‘standing’ preferred display height.

Referring to FIG. 2, when worksurface 115 is in a lowered position, the worksurface 115 may be at a height H_{L} measured vertically from the floor surface 10. Also, the display height-adjustment member 130 is in a lowered or neutral positon, such that the height of the display relative to the worksurface is H_{DL}.

Referring to FIG. 3, when worksurface 115 is in raised position, the worksurface 115 may be at a height H_{R} from the floor surface 10. Also, the display height-adjustment member 130 is in an extended or offset positon. Specifically, the height of display 20 relative to worksurface 115 has been increased by a distance or ‘delta’ H_{Δ}. Accordingly, the height of the display relative to the worksurface has been increased to H_{DR}, where H_{DR}=H_{DL}+H_{Δ}.

In some embodiments, the magnitude of the display height adjustment, i.e. the ‘delta’ H_{Δ} provided by the display height-adjustment member 130 may be between about 1 to 6 inches.

Providing a height-adjustable workstation with an automatic display height-adjustment system may have one or more advantages. For example, a display 20 may be automatically positioned at a preferred height for standing work based on the user's specific body dimensions and/or preferences when the worksurface is moved to a raised position. As a result, a user may not be required to separately adjust the height of the display 20 to their preferred height when adjusting the height of the worksurface 115 between seated and standing work positions.

To facilitate automatic adjustment of the offset or ‘delta’ based on the height of the worksurface 115, a pre-determined ‘triggering’ height between the lowermost and uppermost position of worksurface 115 may be used. For example, if the worksurface 115 is adjustable between a height of about 30 inches to a height of about 40 inches relative to the floor surface 10, the triggering height H_{T} may be adjustable between about 32 inches and about 37 inches. For example, the triggering height H_{T} may be about 32 inches.

For example, as the height of the worksurface 115 is being raised (i.e. being moved upwardly in a direction 12 relative the floor surface 10), once the triggering height H_{T} is crossed, the actuator 150 may be automatically actuated to move the display height-adjustment member 130 to the extended position (e.g. as shown in FIG. 3), thereby moving display mount 145 (and thus display 20) to the extended or offset position. For example, upon detecting or otherwise receiving an indication that height of the worksurface 115 is greater than H_{T}, an actuator controller (not shown), e.g. an electronic switch, may send a signal to actuator 150 directing the actuator 150 to extend the display height-adjustment member 130. The height of the worksurface 115 may be determined in any suitable fashion. For example, a controller for a worksurface actuator (e.g. an actuator included in height-adjustable leg 110) may keep track of the position of the worksurface actuator, and translate this relative to its zero home position to determine the height of the worksurface 115.

Similarly, when the work surface 115 is being lowered (i.e. being moved downwardly in a direction 14 relative the floor surface 10), once the triggering height H_{T} is crossed, the actuator 150 may be automatically actuated to move the display height-adjustment member 130 to the neutral position (e.g. as shown in FIG. 2), thereby returning display mount 145 (and thus display 20) to the retracted or neutral position. For example, upon detecting or otherwise receiving an indication that height of the worksurface 115 is less than H_{T}, the actuator controller may send a signal to actuator 150 directing the actuator 150 to retract the display height-adjustment member 130.

Height-adjustable workstation 100 may also include a control panel 170 that allows a user to adjust the height of worksurface 115. Control panel 170 has one or more user input devices (such as buttons, switches, rockers, touchscreens, and the like) provided thereon that allow a user to selectively control (e.g. raise and lower) the height of worksurface 115. For example, control panel 170 may receive an input from a user directing that the worksurface be raised or lowered. Alternatively, control panel 170 may be accessible over a wired or wireless computer network, or via a short-range communication network (e.g. a Bluetooth network), allowing a user to control the operation via a computing device, such as a smart phone or other mobile communication device, that is not physically connected to workstation 100.

The control panel 170 may also include a digital display 175. A settings menu may be provided and accessed through the digital display 175 to adjust specific parameters of the height-adjustment operation. For example, the triggering height H_{T} may be adjusted via the settings menu on the digital display 175 and programmed into the actuator controller. For example, the triggering height H_{T} may be adjusted in increments (e.g. one inch increments). Additionally, or alternatively, the ‘delta’ H_{Δ} may be adjusted in increments (e.g. one inch increments) via the settings menu on the digital display 175.

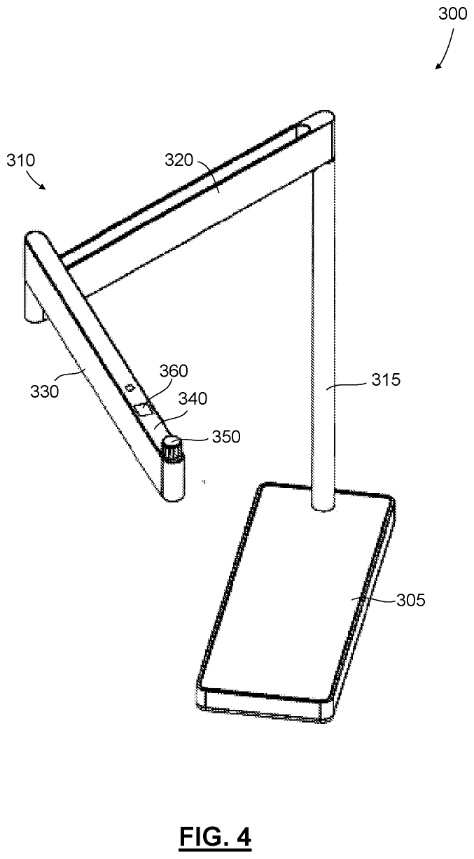

FIG. 4 illustrates an example of an output-adjusting task light, referred to generally as task light 300, in accordance with an embodiment. In the illustrated example, task light 300 includes a support base 305, a frame 310 including a vertical support rod 315 coupled the support base 305, a first horizontal arm 320 coupled to the support rod 315, and a second horizontal arm 330 coupled to the first horizontal arm 320. In the illustrated example, the first horizontal arm 320 and the second horizontal link arm 330 are both rotatable relative to each other and relative to the support base 305. It will be appreciated that appreciated in other embodiments, frame 310 may have any other suitable alternative configuration.

A light emitting element (not shown) is supported by the second horizontal arm 330 and faced downwardly so that it can project light downwardly towards a surface on which the task light is positioned (e.g. a worksurface 115). In the illustrated example, the second horizontal arm 330 has an upper surface 340, and a recess or a hollow in which the light emitting element is disposed. As discussed further below, the light emitting element is operable to provide a range of light output levels. For example, the light emitting element may be adjustable to provide an output level of between 0 and 100 lux. The light emitting element may include one or more LEDs, an incandescent bulb, or any other suitable emitter.

Task light 300 also includes at least one sensor for monitoring an illuminance level of the environment in which the task light is positioned. Preferably, the sensor is positioned above the light emitting element. In the illustrated example, a sensor 360 is positioned on the upper surface 340 of the second horizontal link 330.

Task light 300 also includes a controller (not shown) configured to automatically adjust an output level of the light emitting element based on the illuminance level detected via sensor 360. For example, an illuminance level at the worksurface may be estimated as a sum of the illuminance level of the environment and the illuminance provided by the task light 300. The controller may be programmed with a target worksurface illuminance level, e.g. between 0 and 100 lux. In response to sensor 360 detecting an environmental illuminance level (i.e. the illuminance level provided by environmental light sources other than the task light 300) that is less than the target worksurface illuminance level, the output of the level of the light emitting element may be adjusted such that the combination of the environmental illuminance level and the output of the light emitting element provide the target worksurface illuminance level. For example, if the target worksurface illuminance level is 50 lux and light sensor 360 detects an environmental illuminance level of 20 lux, the output level of the light emitting element adjusted to provide a light output of 30 lux.

In the illustrated example, a rotatable knob 350 is provided to turn the light emitting element on and off, and optionally to adjust the target worksurface illuminance level.

Preferably, the controller is configured to periodically or continuously monitor the illuminance level detected via sensor 360 and automatically adjust the output level of the light emitting element to maintain the target illuminance level at the worksurface. An advantage is that as the environmental illuminance level changes (e.g. if the task light is near a window during the day and a cloud temporarily blocks the sun) the illuminance level at the worksurface may remain more-or-less constant without intervention by a user.

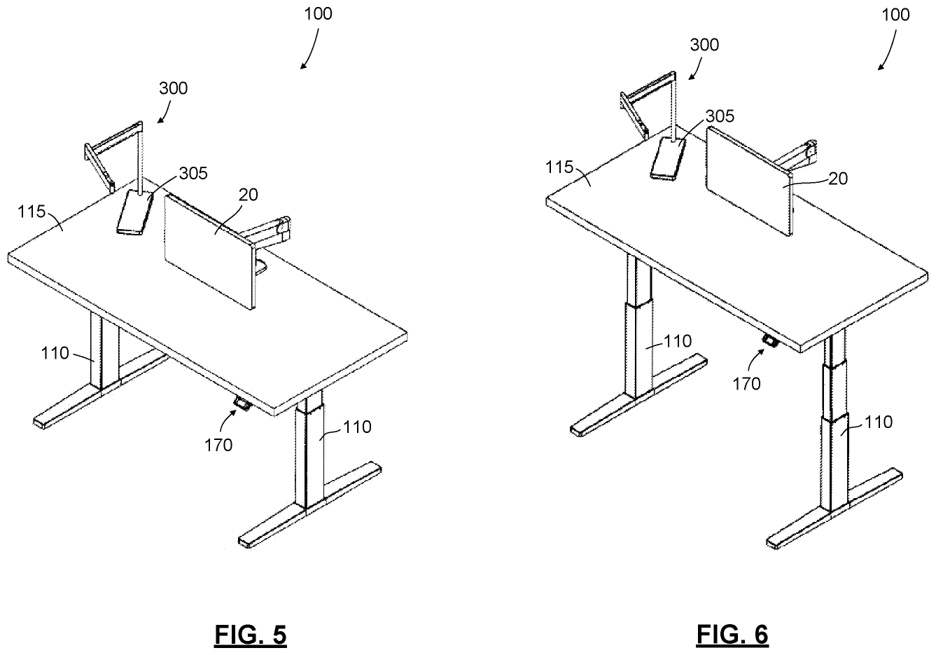

As shown in FIGS. 5 and 6, the output-adjusting task light may be particularly advantageous when placed on a height-adjustable worksurface, such as worksurface 115. For example, the height-adjustable workstation 100 will typically be placed in an indoor location provided with fixed overhead lighting. Thus, the closer the worksurface 115 is to the overhead lighting, the greater will be the illuminance level at the worksurface provided by the overhead lighting. Put another way, the illuminance level at the worksurface may depend, at least in part, on the vertical position of the worksurface 115 relative to any overhead lighting.

For example, FIG. 5 shows a height-adjustable workstation 100 including a task light 300, with the worksurface 115 in a lowered position. When the worksurface 115 is moved to a raised position, e.g. as shown in FIG. 6, presuming the light output of the overhead lighting (not shown) remains constant, light sensor 360 of task light 300 will detect a higher environmental illuminance level than when the worksurface 115 is in a lowered position (since the task light 300 is now closer to the overhead lights). As described above, in response to detecting the increased environmental illuminance level, task light 300 automatically adjusts the output level of the light emitting element. In this way, the task light 300 may provide for a substantially consistent worksurface illuminance level as the worksurface 115 is raised and lowered. As a result, a user may not be required to separately adjust the output level of the task light after moving the worksurface 115 to maintain a desired lighting level at the worksurface.

In some embodiments, the task light 300 may be supplied with power through the height-adjustable workstation. For example, the task light 300 may be plugged into a power outlet (not shown) provided as part of the height-adjustable workstation. Powering the task light 300 through the height-adjustable workstation may provide a desired aesthetic appearance by reducing the number and/or length of power cords extending between the height adjustable workstation and one or more external power outlets.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A height-adjustable workstation comprising:
a worksurface;
at least one worksurface actuator secured to the worksurface for supporting the worksurface above a floor surface;
the at least one worksurface actuator being operable to raise and lower the worksurface relative to the floor surface between a lowered position and a raised position; and
a display support apparatus secured to the worksurface, the display support apparatus comprising a display support actuator and a display mount;
the display support actuator being operable to move the display mount relative to the worksurface between a neutral position and an offset position in which the display mount is further from the worksurface than when the display mount is in the neutral position;
wherein the display support actuator is configured to move the display support to the offset position in response to the worksurface being raised above a pre-determined height relative to the floor surface, and
wherein the display support actuator is configured to move the display support to the neutral position in response to the worksurface being lowered below the pre-determined height.

2. The height-adjustable workstation of claim 1, further comprising at least one height-adjustable leg secured to the worksurface for supporting the worksurface on the floor surface, the at least one height-adjustable leg comprising the at least one worksurface actuator.

3. The height-adjustable workstation of claim 1, wherein the display support actuator comprises a ball screw.

4. The height-adjustable workstation of claim 1, further comprising a control panel operably coupled to the at least one worksurface actuator, the control panel comprising an interface for receiving at least: a first input directing that the worksurface be raised, and a second input directing that the worksurface be lowered.

5. The height-adjustable workstation of claim 4, wherein the control panel further comprises a digital display.

6. The height-adjustable workstation of claim 4, wherein the control panel is operable to receive an offset input for selecting a difference between the offset position and the neutral position.

7. The height-adjustable workstation of claim 6, wherein the offset input comprises selecting the difference between the offset position and the neutral position in one inch increments.

8. The height-adjustable workstation of claim 1, wherein the pre-determined height is between 30 and 42 inches above the floor surface.

9. The height-adjustable workstation of claim 8, wherein the pre-determined height is about 32 inches above the floor surface.

10. The height-adjustable workstation of claim 1, wherein, in the offset position, the display mount is between one and six inches further from the worksurface than when the display mount is in the neutral position.

11. An output-adjusting task light for placement on a worksurface located in an environment, the environment having an environment illuminance level, the output-adjusting task light comprising:
a base configured for placement on the worksurface;
a frame operatively connected to the base, the frame supporting a light emitting element above the worksurface,
the light emitting element being operable to project light downwardly towards the worksurface;
a sensor positioned above the light emitting element,
the sensor being operable to monitor the environment illuminance level; and
a controller operatively coupled to the light emitting element and the sensor,
wherein the controller is configured to adjust an output level of the light emitting element based on the environment illuminance level and a target worksurface illuminance level.

12. The output-adjusting task light of claim 11, wherein the controller is configured to automatically adjust the output level of the light emitting element in response to a change in the environment illuminance level.

13. The output-adjusting task light of claim 11, wherein the controller is configured to determine the output level of the light emitting element based on a difference between the target worksurface illuminance level and the environment illuminance level.

14. The output-adjusting task light of claim 11, further comprising an interface for at least one of receiving the target worksurface illuminance level and adjusting the target worksurface illuminance level.

15. The output-adjusting task light of claim 11, wherein the sensor is positioned on an upper surface of the frame.

16. The output-adjusting task light of claim 11, wherein the output level of the light emitting element is adjustable between 0 and 100 lux.

17. A height-adjustable workstation located in an environment having an environment illuminance level, the workstation comprising:
a worksurface;
at least one worksurface actuator secured to the worksurface for supporting the worksurface above a floor surface;
the at least one worksurface actuator being operable to raise and lower the worksurface relative to the floor surface between a lowered position and a raised position; and
a display support apparatus secured to the worksurface, the display support apparatus comprising a display support actuator and a display mount;
the display support actuator being operable to move the display mount relative to the worksurface between a neutral position and an offset position in which the display mount is further from the worksurface than when the display mount is in the neutral position;
wherein the display support actuator is configured to move the display support to the offset position in response to the worksurface being raised above a pre-determined height relative to the floor surface, and
wherein the display support actuator is configured to move the display support to the neutral position in response to the worksurface being lowered below the pre-determined height;
a task light for placement on the worksurface, the task light comprising:
a base configured for placement on the worksurface;
a frame operatively connected to the base, the frame supporting a light emitting element above the worksurface, the light emitting element being operable to project light downwardly towards the worksurface;
a sensor positioned above the light emitting element, the sensor being operable to monitor the environment illuminance level; and
a controller operatively coupled to the light emitting element and the sensor,
wherein the controller is configured to adjust an output level of the light emitting element based on the environment illuminance level and a target worksurface illuminance level.
